(19) United States
(12) Patent Application Publication
(10) Pub. No.: US 2026/0211970 A1
(43) Pub. Date: Jul. 23, 2026

(54) METHOD AND SYSTEM FOR HYPERCONE ASSISTED CONTOUR GENERATION FOR OUT-OF-DISTRIBUTION DETECTION

(71) Applicant: JPMorgan Chase Bank, N.A., New York, NY (US)

(72) Inventors: Annita VAPSI, New York, NY (US); Andres MUNOZ GARZA, Madrid (ES); Nancy THOMAS, New York, NY (US); Daniel BORRAJO, Pozuelo de Alarcon (ES); Keshav RAMANI, London (GB)

(73) Assignee: JPMorgan Chase Bank, N.A., New York, NY (US)

(21) Appl. No.: 19/033,936

(22) Filed: Jan. 22, 2025

(51) Int. Cl. G06F 17/16

(52) U.S. Cl. CPC G06F 17/16

(57) ABSTRACT

Various methods and processes, apparatuses or systems, and media for distinguishing in-distribution data from out-of-distribution data by generating a set of hypercones within which the in-distribution data lies are disclosed. The method includes: accessing data that is usable in connection with a feature encoder that is defined by an input space and a label output space that includes labels; extracting features from a selected layer; using a feature encoder function to generate embeddings for each extracted feature; using the embeddings to compute, for each label, a respective cluster centroid; computing, for each label, a respective hypercone axis and a respective hypercone opening angle; generating a contour that corresponds to the label output space by projecting hypercones in respective directions based on the data; and determining, based on the contour, whether a particular item of observational data is classifiable as an in-distribution data item.

### TECHNICAL FIELD

This disclosure relates to methods and apparatuses for distinguishing in-distribution data from out-of-distribution data by leveraging the angular distance to the kth neighbor of each datapoint to create a set of hypercones within which the in-distribution data lies.

### BACKGROUND

The developments described in this section are known to the inventors. However, unless otherwise indicated, it should not be assumed that any of the developments described in this section qualify as prior art merely by virtue of their inclusion in this section, or that these developments are known to a person of ordinary skill in the art.

Machine learning models are trained and evaluated on a particular set of data, called the in-distribution (ID) set. During inference, it is possible that a trained model may receive samples drawn from a different distribution to the one on which the model has been trained. These observations are said to be out-of-distribution (OOD). It is important to be able to distinguish between ID and OOD instances for safe and robust model deployment.

Conventional OOD detection methods can be broadly categorized into two groups: training-based methods and post-processing distance-based methods. Training-based methods aim to incorporate OOD detection capabilities directly into the model via train-time regularization. These methods typically modify the objective function or architecture to enhance sensitivity to OOD inputs, for example, by using auxiliary classifiers or network branches targeted at OOD. Such methods may also take a two-step modeling approach, or directly train an OOD detection model to be applied after the initial model. While effective, these methods often require tuning and may sacrifice primary task performance.

Conventional distance-based methods treat OOD detection as a separate post-training step. These methods typically assume OOD data falls far from ID data in the output space and utilize scoring functions like maximum softmax probability, maximum logits, maximum likelihood, energy, and reconstruction error to measure distance between samples. Some such methods construct scoring functions in the feature space of the penultimate layer, when the underlying model is based on a neural network. Distance-based methods are model-agnostic and applicable to pre-trained models if the feature space adequately separates ID and OOD.

The ability to distinguish between ID data and OOD data is also manifested with respect to a technical problem in the consumption of excess power. When a model is trained and/or deployed based on the use of OOD data, the model performance may be compromised, and there may arise a need to retrain and redeploy the model. Moreover, due to the shortcomings of the conventional approaches, if an updated set of training data still retains OOD data by virtue of a failure to adequately distinguish between ID data and OOD data, the process of retraining and redeploying can continue indefinitely. Each cycle of retraining and redeploying consumes a great deal of electrical power. In this aspect, to the extent that a model is trained and deployed using OOD data, and then a need to further distinguish the OOD data leads to a requirement to retrain and redeploy the model, all of the power consumed to that point is completely wasted.

A major challenge in OOD detection is obtaining a labeled and representative OOD dataset, as OOD data may come from numerous sources. Accordingly, there is a need for a mechanism for distinguishing ID data from OOD data in a manner that makes no distributional assumptions about the data.

### SUMMARY

The present disclosure, through one or more of its various aspects, embodiments, and/or specific features or sub-components, provides, among other features, various systems, servers, devices, methods, media, programs, and platforms for distinguishing in-distribution data from out-of-distribution data by leveraging the angular distance to the kth neighbor of each datapoint to create a set of hypercones within which the in-distribution data lies.

According to an aspect of the present disclosure, a method for distinguishing in-distribution data from out-of-distribution data is provided. The method may be implemented by at least one processor. The method may include: accessing a set of data that is usable in connection with a feature encoder that includes a plurality of layers, the feature encoder being defined by an input space that includes a predetermined number of features and a label output space that includes a predetermined number of labels; extracting, from a penultimate layer from among the plurality of layers, a set of features; using a predetermined feature encoder function that is designed to map the input space to a feature output space that corresponds to the set of features to generate, for each respective datapoint included in the set of data, a respective embedding; using each respective embedding to compute, for each respective label included in the label output space, a respective cluster centroid; computing, for each respective label by using each respective embedding and each respective cluster centroid, a respective set of hypercone axes; calculating, for each respective label by using the data, a respective set of hypercone opening angles; generating a contour that corresponds to the label output space by projecting, for each respective cluster centroid, each respective hypercone axis, and each respective hypercone opening angle, a respective hypercone in a respective direction based on the data; using the contour to distinguish, from within the set of data, in-distribution data from out-of-distribution data; and training a predetermined model using a subset of the set of data that includes the in-distribution data and excludes the out-of-distribution data.

The calculating of each respective hypercone opening angle may include: using, for each respective label, a respective subset of the data that corresponds to the respective label to determine, for each respective item of the respective subset of the data, a respective kth nearest neighbor in cosine distance for a predetermined value of k; measuring a respective angle between each respective item of the respective subset of the data and the respective kth nearest neighbor; and setting the measured respective angle as the respective hypercone opening angle.

The method may further include determining, for each respective hypercone, a respective radial boundary by: for each respective item of the data that falls within an angular boundary of the respective hypercone, measuring a respective distance from the respective cluster centroid; and applying a predetermined statistical formula with respect to the measured respective distances to determine the respective radial boundary.

At least a first respective hypercone may overlap with at least a second respective hypercone, such that at least one item of data included in the data falls within both the first respective hypercone and the second respective hypercone.

The method may further include: determining, based on the contour, whether a particular item from within a first set of input observational data is classifiable as an in-distribution data item.

Each respective hypercone may include a respective angular boundary and a respective radial boundary. The determining of whether the particular item is an in-distribution data item may include determining whether the particular item falls within both the respective angular boundary and the respective radial boundary of at least one respective hypercone used for generating the contour.

The method may further include: when a determination is made that the particular item does not fall within both the respective angular boundary and the respective radial boundary of the at least one respective hypercone used for generating the contour, classifying the particular item as an out-of-distribution item.

The method may further include: classifying 95% of items included in the first set of input observational data as in-distribution data items, and classifying 5% of the items included in the first set of input observational data as out-of-distribution data items.

According to another embodiment, a computing apparatus for distinguishing in-distribution data from out-of-distribution data is provided. The computing apparatus includes a processor; a memory; and a communication interface coupled to each of the processor and the memory. The processor may be configured to: access a set of data that is usable in connection with a feature encoder that includes a plurality of layers, the feature encoder being defined by an input space that includes a predetermined number of features and a label output space that includes a predetermined number of labels; extract, from a penultimate layer from among the plurality of layers, a set of features; use a predetermined feature encoder function that is designed to map the input space to a feature output space that corresponds to the set of features to generate, for each respective datapoint included in the set of data, a respective embedding; use each respective embedding to compute, for each respective label included in the label output space, a respective cluster centroid; compute, for each respective label by using each respective embedding and each respective cluster centroid, a respective set of hypercone axes; calculate, for each respective label by using the data, a respective set of hypercone opening angles; generate a contour that corresponds to the label output space by projecting, for each respective cluster centroid, each respective hypercone axis, and each respective hypercone opening angle, a respective hypercone in a respective direction based on the data; use the contour to distinguish, from within the set of data, in-distribution data from out-of-distribution data; and train a predetermined model using a subset of the set of data that includes the in-distribution data and excludes the out-of-distribution data.

The processor may be further configured to calculate each respective hypercone opening angle by: using, for each respective label, a respective subset of the data that corresponds to the respective label to determine, for each respective item of the respective subset of the data, a respective kth nearest neighbor in cosine distance for a predetermined value of k; measuring a respective angle between each respective item of the respective subset of the data and the respective kth nearest neighbor; and setting the measured respective angle as the respective hypercone opening angle.

The processor may be further configured to determine, for each respective hypercone, a respective radial boundary by: for each respective item of the data that falls within an angular boundary of the respective hypercone, measuring a respective distance from the respective cluster centroid; and applying a predetermined statistical formula with respect to the measured respective distances to determine the respective radial boundary.

At least a first respective hypercone may overlap with at least a second respective hypercone, such that at least one item of data included in the data falls within both the first respective hypercone and the second respective hypercone.

The processor may further configured to determine, based on the contour, whether a particular item from within a first set of input observational data is classifiable as an in-distribution data item.

Each respective hypercone may include a respective angular boundary and a respective radial boundary. The processor may be further configured to determine whether the particular item is an in-distribution data item by determining whether the particular item falls within both the respective angular boundary and the respective radial boundary of at least one respective hypercone used for generating the contour.

The processor may be further configured to: when a determination is made that the particular item does not fall within both the respective angular boundary and the respective radial boundary of the at least one respective hypercone used for generating the contour, classify the particular item as an out-of-distribution item.

The processor may be further configured to classify 95% of items included in the first set of input observational data as in-distribution data items, and to classify 5% of the items included in the first set of input observational data as out-of-distribution data items.

According to yet another embodiment, a non-transitory computer readable storage medium storing instructions for distinguishing in-distribution data from out-of-distribution data is provided. The storage medium includes a set of executable code which, when executed by a processor, causes the processor to: access a set of data that is usable in connection with a feature encoder that includes a plurality of layers, the feature encoder being defined by an input space that includes a predetermined number of features and a label output space that includes a predetermined number of labels; extract, from a penultimate layer from among the plurality of layers, a set of features; use a predetermined feature encoder function that is designed to map the input space to a feature output space that corresponds to the set of features to generate, for each respective datapoint included in the set of data, a respective embedding; use each respective embedding to compute, for each respective label included in the label output space, a respective cluster centroid; compute, for each respective label by using each respective embedding and each respective cluster centroid, a respective set of hypercone axes; calculate, for each respective label by using the data, a respective set of hypercone opening angles; generate a contour that corresponds to the label output space by projecting, for each respective cluster centroid, each respective hypercone axis, and each respective hypercone opening angle, a respective hypercone in a respective direction based on the data; use the contour to distinguish, from within the set of data, in-distribution data from out-of-distribution data; and train a predetermined model using a subset of the set of data that includes the in-distribution data and excludes the out-of-distribution data.

When executed, the executable code may further cause the processor to: determine, based on the contour, whether a particular item from within a first set of input observational data is classifiable as an in-distribution data item.

Each respective hypercone may include a respective angular boundary and a respective radial boundary. When executed, the executable code may further cause the processor to determine whether the particular item is an in-distribution data item by determining whether the particular item falls within both the respective angular boundary and the respective radial boundary of at least one respective hypercone used for generating the contour.

When a determination is made that the particular item does not fall within both the respective angular boundary and the respective radial boundary of the at least one respective hypercone used for generating the contour, the executable code may further cause the processor to classify the particular item as an out-of-distribution item.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates a computer system for implementing a method for distinguishing ID data from OOD data by leveraging the angular distance to the kth neighbor of each datapoint to create a set of hypercones within which the ID data lies, in accordance with an embodiment.

FIG. 2 illustrates an exemplary diagram of a network environment with a device for distinguishing ID data from OOD data by leveraging the angular distance to the kth neighbor of each datapoint to create a set of hypercones within which the ID data lies, in accordance with an embodiment.

FIG. 3 illustrates a system diagram for implementing a method for distinguishing ID data from OOD data by leveraging the angular distance to the kth neighbor of each datapoint to create a set of hypercones within which the ID data lies, in accordance with an embodiment.

FIG. 4 illustrates an exemplary flow chart of a process for distinguishing ID data from OOD data by leveraging the angular distance to the kth neighbor of each datapoint to create a set of hypercones within which the ID data lies, in accordance with an embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

As is traditional in the field of the present disclosure, example embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions. Also, each block, unit and/or module of the example embodiments may be physically separated into two or more interacting and discrete blocks, units and/or modules without departing from the scope of the inventive concepts. Further, the blocks, units and/or modules of the example embodiments may be physically combined into more complex blocks, units and/or modules without departing from the scope of the present disclosure.

As disclosed herein, a system or method for distinguishing ID data from OOD data by leveraging the angular distance to the kth neighbor of each datapoint to create a set of hypercones within which the ID data lies may improve the performance of a trained machine learning model by improving an accuracy of a determination of which observational data is OOD data without requiring distributional assumptions about the feature space of the model, other than an assumption that the ID data is separable from the OOD data within the feature space, and thereby reducing a likelihood that the model will erroneously rely on OOD data in making predictions and assessments of subsequently inputted data. In particular, the system or method may achieve these improvements by: accessing a set of data that is usable in connection with a feature encoder that includes a plurality of layers, the feature encoder being defined by an input space that includes a predetermined number of features and a label output space that includes a predetermined number of labels; extracting, from a penultimate layer from among the plurality of layers, a set of features; using a predetermined feature encoder function that is designed to map the input space to a feature output space that corresponds to the set of features to generate, for each respective datapoint included in the set of data, a respective embedding; using each respective embedding to compute, for each respective label included in the label output space, a respective cluster centroid; computing, for each respective label by using each respective embedding and each respective cluster centroid, a respective set of hypercone axes; calculating, for each respective label by using the data, a respective set of hypercone opening angles; and generating a contour that corresponds to the label output space by projecting, for each respective cluster centroid, each respective hypercone axis, and each respective hypercone opening angle, a respective hypercone in a respective direction based on the data.

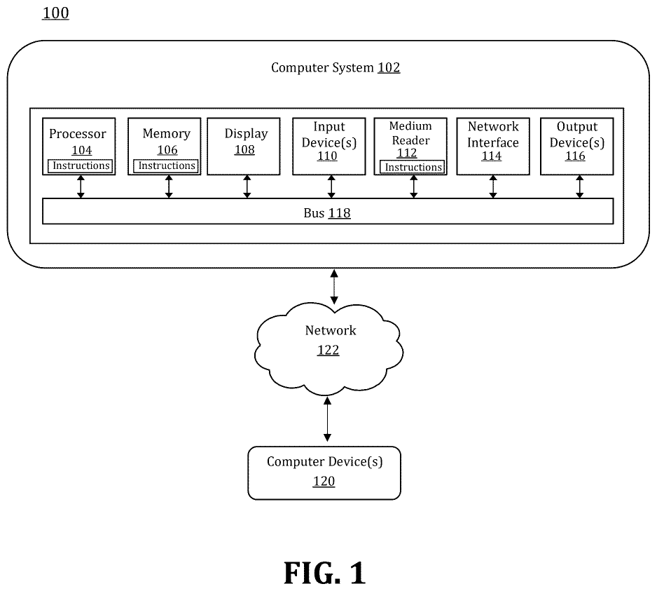

FIG. 1 is an exemplary system 100 for use in implementing a method for distinguishing ID data from OOD data by leveraging the angular distance to the kth neighbor of each datapoint to create a set of hypercones within which the ID data lies, in accordance with an embodiment. The system 100 is generally shown and may include a computer system 102, which is generally indicated.

The computer system 102 may include a set of instructions that may be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such a cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term system shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions may be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other known display.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a GPS device, a visual positioning system (VPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, may be used to perform one or more of the methods and processes as described herein. In a particular embodiment, the instructions may reside completely, or at least partially, within the memory 106, the medium reader 112, and/or the processor 104 during execution by the computer system 102.

Furthermore, the computer system 102 may include any additional devices, components, parts, peripherals, hardware, software, or any combination thereof which are commonly known and understood as being included with or within a computer system, such as, but not limited to, a network interface 114 and an output device 116. The output device 116 may be, but is not limited to, a speaker, an audio out, a video out, a remote control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In some embodiments, the modules implemented by the system 100 may be platform, language, database, and cloud agnostic that may allow for consistent easy orchestration and passing of data through various components to output a desired result regardless of platform, browser, language, database, and cloud environment by writing programs accordingly. The configuration or data files, in some embodiments, may be written using JavaScript Object Notation (JSON), but the disclosure is not limited thereto. For example, the configuration or data files may easily be extended to other readable file formats such as Extensible Markup Language (XML), YAML Ain′t Markup Language (YAML), etc., or any other configuration-based languages.

In accordance with various embodiments of the present disclosure, the methods described herein may be implemented using a hardware computer system that executes software programs. Further, in a non-limited embodiment, implementations can include distributed processing, component/object distributed processing, and an operation mode having parallel processing capabilities. Virtual computer system processing may be constructed to implement one or more of the methods or functionality as described herein, and a processor described herein may be used to support a virtual processing environment.

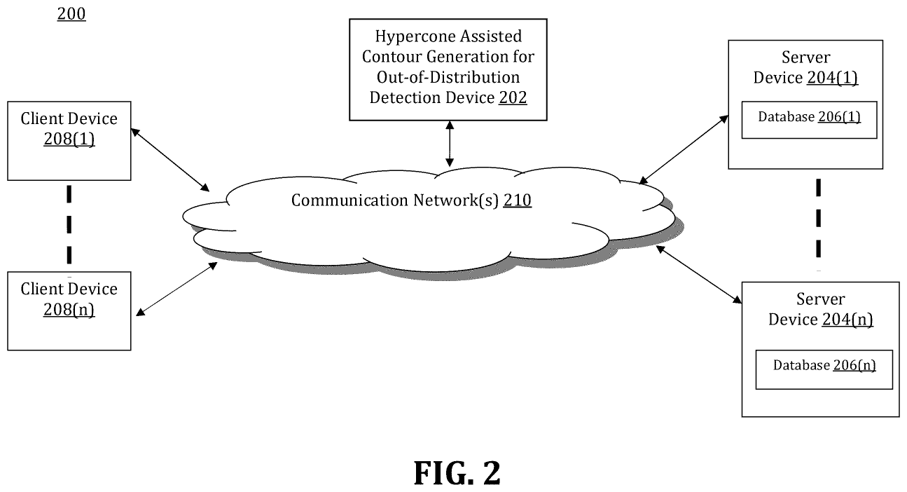

Referring to FIG. 2, a schematic of an exemplary network environment 200 for implementing a hypercone assisted contour generation for out-of-distribution detection device (HACGOODDD) of the instant disclosure is illustrated.

In some embodiments, the above-described problems associated with conventional tools may be overcome by implementing a HACGOODDD 202 as illustrated in FIG. 2 that may be configured for implementing a method for distinguishing ID data from OOD data by leveraging the maximum angular distance to the kth neighbor of each datapoint to create a set of hypercones within which the ID data lies, but the disclosure is not limited thereto.

The HACGOODDD 202 may have one or more computer system 102s, as described with respect to FIG. 1, which in aggregate provide the necessary functions.

The HACGOODDD 202 may store one or more applications that can include executable instructions that, when executed by the HACGOODDD 202, cause the HACGOODDD 202 to perform actions, such as to transmit, receive, or otherwise process network messages, for example, and to perform other actions described and illustrated below with reference to the figures. The application(s) may be implemented as modules or components of other applications. Further, the application(s) may be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the HACGOODDD 202 itself, may be located in virtual server(s) running in a cloud-based computing environment rather than being tied to one or more specific physical network computing devices. Also, the application(s) may be running in one or more virtual machines (VMs) executing on the HACGOODDD 202. Additionally, in one or more embodiments of this technology, virtual machine(s) running on the HACGOODDD 202 may be managed or supervised by a hypervisor.

In the network environment 200 of FIG. 2, the HACGOODDD 202 is coupled to a plurality of server devices 204(1)-204(n) that hosts a plurality of databases 206(1)-206(n), and also to a plurality of client devices 208(1)-208(n) via communication network(s) 210. A communication interface of the HACGOODDD 202, such as the network interface 114 of the computer system 102 of FIG. 1, operatively couples and communicates between the HACGOODDD 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the HACGOODDD 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The HACGOODDD 202 may be a standalone device or integrated with one or more other devices or apparatuses, such as one or more of the server devices 204(1)-204(n), for example. In one particular example, the HACGOODDD 202 may be hosted by one of the server devices 204(1)-204(n), and other arrangements are also possible. Moreover, one or more of the devices of the HACGOODDD 202 may be in the same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the HACGOODDD 202 via the communication network(s) 210 according to the HyperText Transfer Protocol (HTTP)-based and/or JSON protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store various types of data.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. Client device in this context refers to any computing device that interfaces to communications network(s) 210 to obtain resources from one or more server devices 204(1)-204(n) or other client devices 208(1)-208(n).

In some embodiments, the client devices 208(1)-208(n) in this example may include any type of computing device that can facilitate the implementation of the HACGOODDD 202 that may efficiently provide a platform for implementing a method for distinguishing ID data from OOD data by leveraging the angular distance to the kth neighbor of each datapoint to create a set of hypercones within which the ID data lies, but the disclosure is not limited thereto.

The client devices 208(1)-208(n) may run interface applications, such as standard web browsers or standalone client applications, which may provide an interface to communicate with the HACGOODDD 202 via the communication network(s) 210 in order to communicate user requests. The client devices 208(1)-208(n) may further include, among other features, a display device, such as a display screen or touchscreen, and/or an input device, such as a keyboard, for example.

Although the exemplary network environment 200 with the HACGOODDD 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as may be appreciated by those skilled in the relevant art(s).

One or more of the devices depicted in the network environment 200, such as the HACGOODDD 202, the server devices 204(1)-204(n), or the client devices 208(1)-208(n), for example, may be configured to operate as virtual instances on the same physical machine. For example, one or more of the HACGOODDD 202, the server devices 204(1)-204(n), or the client devices 208(1)-208(n) may operate on the same physical device rather than as separate devices communicating through communication network(s) 210. Additionally, there may be more or fewer HACGOODDDs 202, server devices 204(1)-204(n), or client devices 208(1)-208(n) than illustrated in FIG. 2. In some embodiments, the HACGOODDD 202 may be configured to send code at run-time to remote server devices 204(1)-204(n), but the disclosure is not limited thereto.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

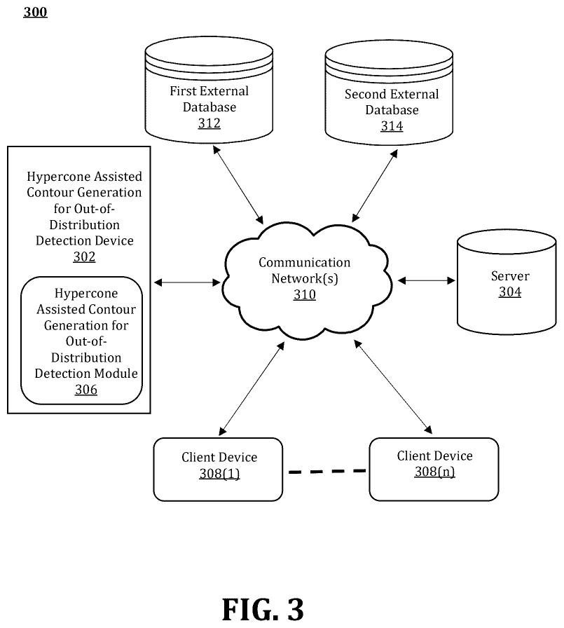

FIG. 3 illustrates a system diagram for implementing an HACGOODDD 302 having a hypercone assisted contour generation for out-of-distribution detection module (HACGOODDM), in accordance with an embodiment.

As illustrated in FIG. 3, the system 300 may include an HACGOODDD 302 within which an HACGOODDM 306 is embedded, a server 304, a first external database 312, a second external database 314, a plurality of client devices 308(1) . . . 308(n), and a communication network 310.

In some embodiments, the HACGOODDD 302 including the HACGOODDM 306 may be connected to the server 304, and the database(s) 312 via the communication network 310. The HACGOODDD 302 may also be connected to the plurality of client devices 308(1) . . . 308(n) via the communication network 310, but the disclosure is not limited thereto.

In an embodiment, the HACGOODDD 302 is described and shown in FIG. 3 as including the HACGOODDM 306, although it may include other rules, policies, modules, databases, or applications, for example. In some embodiments, the first external database 312 and/or the second external database 314 may be configured to store ready to use modules written for each application programming interface (API) for all environments. Although only one database is illustrated in FIG. 3, the disclosure is not limited thereto. Any number of desired databases may be utilized for use in the disclosed invention herein. The databases 312, 314 may be a mainframe database, a log database that may produce programming for searching, monitoring, and analyzing machine-generated data via a web interface, etc., but the disclosure is not limited thereto.

In some embodiments, the HACGOODDM 306 may be configured to receive real-time feed of data from the plurality of client devices 308(1) . . . 308(n) and secondary sources via the communication network 310.

As may be described below, the HACGOODDM 306 may be configured to: access data that is usable in connection with a feature encoder that is defined by an input space and a label output space that includes labels; extracting features from a selected layer of the feature encoder; use a feature encoder function to generate embeddings for each extracted feature; use the embeddings to compute, for each label, a respective cluster centroid; computing, for each label, a respective set of hypercone axes, a respective set of hypercone opening angles, and a respective hypercone radial boundary; generating a contour that corresponds to the label output space by projecting hypercones in respective directions based on the data; and determining, based on the contour, whether a particular item of observational data is classifiable as an in-distribution data item, but the disclosure is not limited thereto.

The plurality of client devices 308(1) . . . 308(n) are illustrated as being in communication with the HACGOODDD 302. In this regard, the plurality of client devices 308(1) . . . 308(n) may be “clients” (e.g., customers) of the HACGOODDD 302 and are described herein as such. Nevertheless, it is to be known and understood that the plurality of client devices 308(1) . . . 308(n) need not necessarily be “clients” of the HACGOODDD 302, or any entity described in association therewith herein. Any additional or alternative relationship may exist between either or both of the plurality of client devices 308(1) . . . 308(n) and the HACGOODDD 302, or no relationship may exist.

The first client device 308(1) may be, for example, a smart phone. Of course, the first client device 308(1) may be any additional device described herein. The second client device 308(n) may be, for example, a personal computer (PC). Of course, the second client device 308(n) may also be any additional device described herein. In some embodiments, the server 304 may be the same or equivalent to the server device 204 as illustrated in FIG. 2.

The process may be executed via the communication network 310, which may comprise plural networks as described above. For example, in an embodiment, one or more of the plurality of client devices 308(1) . . . 308(n) may communicate with the HACGOODDD 302 via broadband or cellular communication. Of course, these embodiments are merely exemplary and are not limiting or exhaustive.

The computing device 301 may be the same or similar to any one of the client devices 208(1)-208(n) as described with respect to FIG. 2, including any features or combination of features described with respect thereto. The HACGOODDD 302 may be the same or similar to the HACGOODDD 202 as described with respect to FIG. 2, including any features or combination of features described with respect thereto.

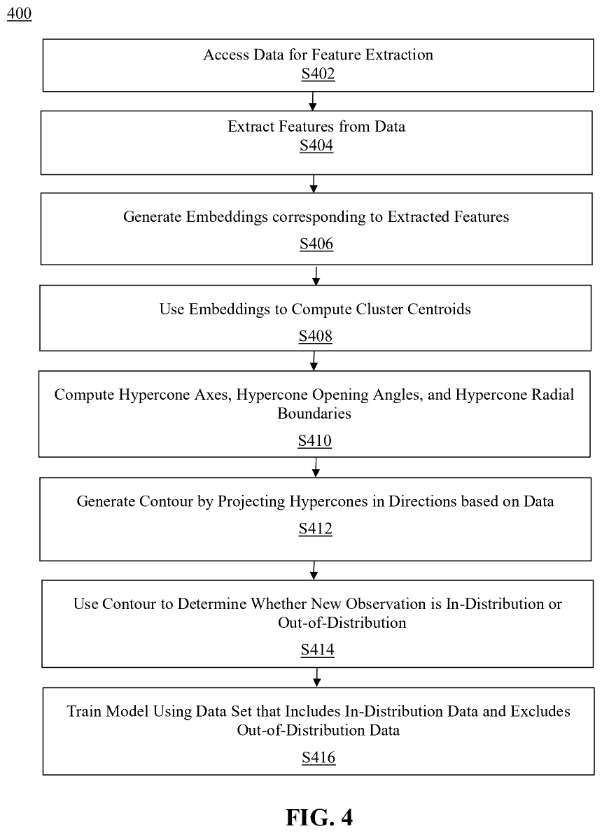

FIG. 4 illustrates an exemplary flow chart of a process 400 implemented by the HACGOODDM 306 of FIG. 3 for enablement of a system and a method for distinguishing ID data from OOD data by leveraging the angular distance to the kth neighbor of each datapoint to create a set of hypercones within which the ID data lies, in accordance with an embodiment. It may be appreciated that the illustrated process 400 and associated steps may be performed in a different order, with illustrated steps omitted, with additional steps added, or with a combination of reordered, combined, omitted, or additional steps.

As illustrated in FIG. 4, at step S402, the process 400 may include accessing a set of data that is usable for training a feature encoder. In an embodiment, the data may be image data, but the present disclosure is not limited thereto. Alternatively, the data may be any one or more of text data, tabular data, time series data, and/or any other suitable type of data. In an embodiment, the feature encoder may be a neural network, but the present disclosure is not limited thereto. In an embodiment, the image data may include photographs or drawings or renderings of objects or scenes that are deemed suitable for training the feature encoder and/or neural network. For example, the image data may include one or more photographs of an urban setting that includes a street, automobiles, pedestrians, buildings, traffic signs, and any other type of object that may be typical in an urban setting. As another example, the image data may include a drawing or a rendering of a human body. As yet another example, the image data may include one or more photographs of an interior of a residential home. As yet another example, the image data may include images of astronomical objects in outer space that are generated by one or more satellites or telescopes. In an embodiment, the image data may be stored in a database or a memory that is accessible to the HACGOODDM 306. Alternatively, the image data may be provided to the HACGOODDM 306 as a result of an electronic transmission from an external entity, such as an email message that includes the image data as one or more attachments, or via an upload to a repository that is executed by the external entity.

In an embodiment, the neural network may include a predetermined number of layers, including an input layer, an output layer, and one or more hidden layers. In an embodiment, the neural network may be defined by an input space that includes a predetermined number of channels and a label output space that includes a predetermined number of labels. In an embodiment, each channel corresponds to a potential set of values that may be inputted thereto, and the label output space corresponds to a set of all possible output values or categories that may be predicted or assigned to input data points by the neural network. In an embodiment, the label output space may correspond to a supervised setting, where the labels are already included in the data, or to an unsupervised setting, where the labels may be determined by using, for example, a clustering algorithm.

At step S404, the process 400 may include extracting a set of features from a penultimate layer of the feature encoder and/or neural network. In an embodiment, the term “features” refers to variables and/or attributes of input data that are usable as predictors of outputs by the feature encoder and/or neural network. For example, if the neural network is to be used for classifying an animal as either a cat or a dog, and the image data included photographs or drawings of different cats and dogs, the features may include attributes such as weight, tail length, ear size, and/or any other physical aspect that may be usable for distinguishing cats from dogs.

At step S406, the process 400 may include using a predetermined feature encoder function that is designed to map the input space of the feature encoder and/or neural network to a feature output space that corresponds to the set of features extracted in step S402, in order to generate a respective embedding for each respective feature. In an embodiment, an embedding (also referred to herein as a “vector embedding” and/or a “vector”) may refer to an array of numbers that can be used to represent a piece of information, such as text, graphical information, and/or images. In an embodiment, a word embedding may refer to a numerical representation of a word that captures a semantic meaning of the word; a graph embedding may refer to a numerical representation of a node in a graph that preserves the structural information of the graph in the context of the embedding space; and an image embedding may refer to a numerical representation of an image that captures visual aspects of the image. In an embodiment, the embedding may be generated by using a known embedding model, such as, for example, CodeBERT.

At step S408, the process 400 may include using each respective embedding to compute a respective cluster centroid for each respective label included in the label output space. In an embodiment, the term “cluster centroid” refers to a mean value of the embeddings for all in-distribution training set observations for a particular label, i.e., cluster.

At step S410, the process 400 may include computing a respective set of hypercone axes, a respective set of hypercone opening angles, and a respective hypercone radial boundary for each respective label. In an embodiment, each hypercone axis may be computed by aligning an axis in the direction of training set in-distribution observation data and extending outwards from the corresponding cluster centroid. In an embodiment, each hypercone opening angle may be computed as follows: using a subset of the data that corresponds to the respective label to determine, for each respective item of the subset of the data, a respective kth nearest neighbor in cosine distance for a predetermined value of k; measuring a respective angle between each respective item of the subset of the data and the respective kth nearest neighbor; and setting the measured respective angle as the respective hypercone opening angle. In an embodiment, the respective radial boundary may be computed as follows: after computing the respective hypercone opening angle, for each respective item of the data that falls within an angular boundary that corresponds to the respective hypercone opening angle, measuring a respective distance from the respective cluster centroid; and applying a predetermined statistical formula with respect to the measured respective distances to determine the respective hypercone radial boundary. In an embodiment, the predetermined statistical formula may include adding two standard deviations to a mean value of the measured respective distances; but the present disclosure is not limited thereto. Alternatively, the predetermined statistical formula may include adding one standard deviation to the mean value, or the formula may include adding any suitable number of standard deviations to the mean value.

At step S412, the process 400 may include generating a contour that corresponds to the label output space by projecting, for each respective cluster centroid, each respective hypercone axis, each respective hypercone opening angle, and each respective hypercone radial boundary, a respective hypercone. In an embodiment, each respective hypercone is projected in a direction that corresponds to the direction of the respective training set in-distribution observation data that is aligned with the respective hypercone axis. In an embodiment, in some instances, there will be an overlap between adjacent hypercones, such that at least one item of data included in the data falls within more than one such hypercone.

At step S414, the process 400 may include using the contour to determine whether a new observation is classifiable as being in-distribution (ID) data or out-of-distribution (OOD) data. In an embodiment, the new observation may correspond to a particular item from within a first set of input observational data, such as, for example, a new set of image data that is inputted by an external entity. In an embodiment, the determination as between ID data and OOD data may be made by determining whether the particular item of observational data falls within both the respective angular boundary and the respective radial boundary of at least one of the hypercones that is used for generating the contour. When the particular item of observational data does fall within both boundaries of at least one hypercone, then that particular item may be determined as being ID data; and when the particular item of data does not fall within both boundaries of any of the hypercones, then that particular item may be determined as being OOD data. In an embodiment, at least 90% of the items included in the first set of input observational data may be classifiable as ID data and at most 10% of the items included in the first set of input observational data may be classifiable as OOD data. For example, 95% of the items included in the first set of input observational data may be classifiable as ID data and 5% of the items included in the first set of input observational data may be classifiable as OOD data. However, the present disclosure is not limited thereto, and the percentage of items included in the first set of input observational data that may be classifiable as ID data may be any percentage between 0% and 100%.

At step S416, the process 400 may include using a subset of the set of data accessed in step S402 within which ID data is included and OOD data is excluded to train a particular model, such as, for example, the feature encoder. In this aspect, by ensuring that the particular model is trained by using a data set that includes ID data and excludes OOD data, the performance of the particular model is improved, and a potential need to retrain and redeploy the particular model is mitigated, thereby resulting in a significant savings in electrical power.

In an embodiment, a system and a method for class contour generation by employing hypercone projections is disclosed, in order to provide a representation for the ID manifold in the feature space. In an embodiment, no strong distributional assumptions about the feature space are made, other than that ID and OOD data are separable in the space. The generated contour separates ID from OOD data by considering the variability of the ID data in the directions of the projected hypercones from the class centroid.

In an embodiment, the task may be framed as a multi-class classification problem. It is assumed that X⊆ [symbol] represents an input space for a classifier model, where D=C×W×H, in which C denotes the number of channels, and W×H denotes the size of an image. The output space Y of the model is defined as {1, . . . , |Y|}. The goal of the classification problem is to learn a mapping: ƒ:X→Y, which assigns each input observation to one of the |Y| classes. A neural network f that is trained on samples drawn from the joint distribution P_{XY} is employed, where Pᵢₙ represents the marginal distribution over X. The network outputs a set of logits, which is used to predict the label for a given input.

Given a classifier model, such as the one outlined above, one objective is for the model to accurately classify images into one of the |Y| labels (ID), while also being able to detect unknown observations (OOD). Historically, distance-based methods in OOD detection have utilized level set estimation in a binary classification approach to determine whether or not observations are drawn from Pᵢₙ.

Mathematically, level set estimation involves partitioning the input space into regions where the output of the classifier output lies above or below a certain threshold. Let f(x) represent the output (e.g., logits or probabilities) of the classifier for input x. The decision boundary is determined by a threshold λ, such that:

$$Decision ( x ) = 1 \{ S ( f ( x ) ) > λ \} \qquad ( 1 )$$

where 1{⋅} describes the binary classifier in the form of an indicator function, which classifies a sample as ID when the scoring function S(·) produces a score greater than the scalar threshold value λ. The threshold λ may be chosen based on properties of the training data and/or through validation techniques to optimize performance. This approach effectively creates a boundary in the input space, separating regions where the model is confident in its predictions (ID) from regions where the model is uncertain or likely to make errors (OOD) input.

As embedding-based methods tend to outperform probability-based metrics in distance-based OOD detection, the present disclosure focuses in this space. Parametric distance-based methods, however, necessitate assumptions on the distribution of ID data in the feature space. Thus, such methods are likely to fail in cases where the distribution has an irregular shape, and are less likely to capture areas of the distribution which do not adhere to the assumptions. By contrast, the systems and methods of the present disclosure are designed to capture the contour of ID data without making assumptions on the distribution of the embedding space. In an embodiment, this may be achieved by using hypercones which flexibly map the embedding space locally, allowing more precise separation of ID and OOD data.

In particular, the systems and methods of the present disclosure relax the normality assumption that would otherwise constrain the class contour to a hypersphere or multidimensional ellipsoid. Instead, the class contour may be approximated with a set of hypercones parameterized by a pre-specified angle. Consequently, these systems and methods refrain from assuming a Gaussian distribution for the feature embedding space, and the borders of the contour are described by projecting multidimensional hypercones in appropriate directions. In an embodiment, this approach may allow for a more flexible representation of the class contour.

By contrast with classical distance-based methods, where a single distance cutoff threshold is selected for the full dataset, a more nuanced strategy may be employed. In an embodiment, a distinct distance cutoff per projected hypercone may be assigned, based on a determination thereof by the observed variation in ID distances along the direction of each hypercone. The aim of this approach is to accommodate a diverse set of thresholds across different directions. In this aspect, the systems and methods of the present disclosure are unrestricted in shaping the contour of ID observations, thereby fostering greater flexibility and adaptability.

In an embodiment, a pre-trained classification network is used. An extraction of multi-dimensional embedding space features from the penultimate layer of the network is performed, and the result of this extraction serves as the feature encoder layer. Let f_{encoder}(x) represent the feature encoder network, a subset of the full classification network, which maps input data x to the extracted features z, where f_{encoder}:X→Z is the mapping function from the input space X to the output space Z. An extraction is performed for the embedding features of the training set of ID observations Zₜᵣₐᵢₙ={zₜᵣₐᵢₙ_{₁}, . . . , zₜᵣₐᵢₙ_{ₙ}}, the test set of ID observations Zₜₑₛₜ={zₜₑₛₜ_{₁}, . . . , zₜₑₛₜ_{ₙ}}, and the unseen test set of observations Z_{ood}={z_{odd}_{₁}, . . . , z_{ood}_{ₙ}}.

A description of terminology that relates to a hypercone follows. The apex or vertex of a hypercone, denoted as V, is the central point from which all generating lines originate. The axis of the hypercone, denoted as ā, is a straight line passing through the apex, V and some other point P. This axis acts as the central axis of symmetry, defining the primary direction along which the hypercone extends and maintains its symmetry. The slant height of a hypercone is the length of the line segment connecting the apex to any point on the surface of the hypercone. The opening angle of the hypercone is the angle between the hypercone axis and any line starting at the apex and extending along the slant height of the hypercone. This opening angle measures how much the hypercone widens or narrows as it extends from the apex along its axis. Mathematically, if a line along the slant height is denoted as \vec{s}, the opening angle θ can be expressed as:

$$cos θ = \frac{\vec{a} \cdot \vec{s}}{‖ \vec{a} ‖ ‖ \vec{s} ‖} \qquad ( 2 )$$

Here, ⋅ denotes the dot product and ∥⋅∥ denotes the magnitude, or length, of a vector. Therefore, a hypercone hᵢ may be denoted according to its parameters as (hᵢ(\vec{a}ᵢ,θᵢ)).

The following is a description of how to create hypercones, each defined by an axis and opening angle, using the ID features. First, the class contours for the ID training set observations in the embedding space are computed, with one contour for each label. The goal is to best describe the boundaries of each class in the embedding space with a set of hypercones. In an embodiment, for each class, a respective centroid Cₗ is computed as the mean of all ID train set observations belonging to that class. This creates a set of centroids, C. In cases where the model architecture dictates that the embeddings be normalized, different centroids may be chosen to reflect the new normalized cluster shapes. Normalizing the features effectively projects them onto a unit sphere in the embedding space, resulting in clusters with a disk-like shape. Since the normalized cluster shapes are non-convex, the initial centroids may fall outside the cluster boundaries. To obtain a good approximation of the class centroids within the cluster, each centroid is replaced by its nearest train set observation using cosine distance. Each centroid will be the apex of all hypercones for its class. To reposition the embedding features centered at one of the centroids, rather than at the origin of the feature space, a centered version of each Z may be computed as follows:

$${Z}_{train} = \{ \{ z - {C}_{l} \} ∀ l ∈ Y , z ∈ {Z}_{{train}_{i}} \} \qquad ( 3 )$$

$${Z}_{test} = \{ \{ z - {C}_{l} \} ∀ l ∈ Y , z ∈ {Z}_{{test}_{i}} \} \qquad ( 4 )$$

For Z_{ood}, there are no labels. Therefore, the embeddings may be centered relative to each label, effectively generating a new set of OOD embeddings per label, as follows:

$${Z}_{train} = \{ \{ z - {C}_{l} \} ∀ z ∈ {Z}_{ood} , l ∈ Y \} \qquad ( 5 )$$

In this aspect, from here onwards, Zₜᵣₐᵢₙ, Zₜₑₛₜ and Z_{ood} refer to the centered versions of the respective original set of embeddings.

The set of all hypercones which are parameterized by axis and opening angle are then constructed. The set of all axes for all hypercones for label l may be defined as:

$${A}_{i} = \{ \vec{{C}_{l} z} ∀ z ∈ {Z}_{{train}_{i}} \} \qquad ( 6 )$$

The set of all axes for all labels may therefore be defined as A={Aₗ∀l∈Y}.

In an embodiment, a respective opening angle θ for each hypercone may be determined by calculating the cosine distance between its axis and its k-th nearest neighbor, where k is a parameter. Given that the axis of the hypercone belongs to one of the train set classes, the corresponding set of nearest neighbors is taken to be the set of all train set observations belonging to that class. By determining the angle to the k-th nearest neighbor, there is an assurance that each respective hypercone includes at least k observations within its respective boundary. Let KNNAngle(⋅) be a function that takes an axis of a hypercone and the set of all neighbors for the axis as inputs, and finds the k-th nearest neighbor of the axis in cosine distance and consequently the angle between the two. Then, the set of opening angles for all hypercones for label l can be defined as:

$${T}_{l} = \{ KNNAngle ( {α}_{j} , {Z}_{{train}_{i}} ) ∀ j ∈ \{ 1 , … , \vert {A}_{l} \vert \} \} \qquad ( 7 )$$

The set of all opening angles for all labels can therefore be defined as T={Tₗ∀l∈Y}.

From Equations 6 and 7, the axes and angles to define the set of hypercones for label l may be extracted. More specifically, for every j∈{1, . . . , |Aₗ|}, an extraction of θⱼ∈Tₗ,αⱼ∈Aₗ is made, and Hₗ is defined as follows:

$${H}_{l} = \{ h ( \vec{{a}_{j}} , {θ}_{j} ) ∀ j ∈ \{ 1 , … , \vert {A}_{l} \vert \} \} \qquad ( 8 )$$

The set of all hypercones for all labels is therefore defined as H={Hₗ∀l∈Y}.

The hypercones H initially extend outwards from the pre-computed centroids C without a boundary, serving as filters within the embedding space. While hypercones have a boundary established by a height parameter, this definition may be loosely modified to include a radial boundary. To determine the appropriate radial boundary for hypercone h, an examination of the distribution of Zₜᵣₐᵢₙ_{₁} and Zₜₑₛₜ_{₁} contained in h is performed, or in other words, an examination is performed of the ID feature vectors which fall within the angular boundary of hypercone h. First, this set is defined for each h. For each z∈{Zₜᵣₐᵢₙ_{ₗ}, Zₜₑₛₜ_{ₗ}}, a computation is made of the angle between the hypercone axis \vec{a} corresponding to h and the vector \vec{Cₗz} extending from the centroid of the cluster Cₗ to the feature observation z. This angle is denoted as τ. If τ<θ, where θ is the opening angle of h, then z falls within the angular boundary of hypercone h.

For a given hypercone h_{l,i}, let G_{l,i} be the set of observations falling within its angular boundaries, in accordance with the following:

$${G}_{l , i} = \{ z ∀ z ∈ {Z}_{{train}_{i}} ⋃ {Z}_{test} , \vert 𝒯 < {θ}_{l , i} \} \qquad ( 9 )$$

where τ is the angle between observation z, and θ_{l,i} is the opening angle of h_{l,i}. Computations are made of the distances between the apex point Cₗ, of hypercone h_{l,i}, and each observation g∈G_{l,i}. This set of distances for hypercone h_{l,i} is then given by:

$${D}_{l . i} = \{ \vert \vec{{C}_{lg}} \vert ∀ g ∈ {G}_{l , i} \} \qquad ( 10 )$$

The distribution of distances in set D_{l,i} is used to determine a preliminary radial boundary for hypercone h_{l,i}, which, in an embodiment, may be taken to be the mean, μ, plus two standard deviations, 2σ, of set D_{l,i}.

$${b}_{l , i} = μ + 2 σ \qquad ( 11 )$$

This boundary is chosen to exclude points which lie far from the class centroid and ensure that the hypercones are robust against outliers. Alternatively, a different statistical formula may be used with respect to the distribution of distances, such as, for example, adding the mean to one standard deviation, adding the mean to three standard deviations, and/or adding the mean to any suitable number of standard deviations.

The computed distances are normalized by the radial boundary as follows:

$${D}_{l , i}^{norm} = \{ \frac{d}{{b}_{l , i}} ∀ d ∈ {D}_{l , i} \} \qquad ( 12 )$$

In an embodiment, the aforementioned steps are applied to all generated hypercones and observations. The normalization step of Equation 12 provides the scoring function S(⋅) as defined in Equation 1. The computed scores may then be used in level set estimation, and ensure that the results are reported at a pre-determined true positive rate (TPR). In an embodiment, the TPR may be set to 95%, effectively ensuring that 95% of all ID observations are correctly classified as in-distribution. The score at the 95-th percentile, λ, effectively becomes the final radial boundary of the hypercones. The final contour per class comprises of the union of the constructed hypercones for that class. However, setting the TPR to 95% represents just one example, and the present disclosure is not limited thereto. Alternatively, the TPR may be set to 90%, 85%, 92.5%, 97.5%, or to any other suitable value.

In an embodiment, the contour may then be used to perform an OOD inference operation. During OOD inference, the hypercones are employed to determine whether a new observation in the embedding space, z, is ID or OOD. This decision is made by checking whether or not the observation falls within both the angular and radial boundaries of any of the generated hypercones, in any of the clusters, using the same method as described above. The expression z∈hᵢ may be used to mean that observation z falls within both angular and radial boundaries of hypercone hᵢ. If it does for any hypercone hᵢ, it is labeled as ID, and OOD otherwise. Thus, the level-set estimation formulation transforms to an OOD detector framework defined as follows:

$$Decision ( z ) = \{ \begin{matrix}ID & if ∃ {h}_{i} ∈ {H}_{l} ∀ l ∈ Y s . t . z ∈ {h}_{i} \\ OOD & otherwise\end{matrix} \qquad ( 13 )$$

The hypercones inherently aim to delineate the contour of ID observations by allowing for fluid boundaries between ID and OOD observations in different areas of the embedding space, as opposed to conventional approaches that rely on a single distance threshold for the entire space. Additionally, by utilizing ID observations as the hypercone axes, there is an assurance that the contour is generated by scanning the appropriate directions, and this also facilitates the generation of overlapping hypercones in densely populated areas of the embedding space. This approach smooths out the surface of the contour, thereby reducing the effects of outliers, akin to fitting a polynomial curve using interpolation techniques.

In some embodiments as disclosed above in FIGS. 1-4, technical improvements effected by the instant disclosure may include a platform for implementing a hypercone assisted contour generation for out-of-distribution detection module configured for enablement of distinguishing ID data from OOD data by leveraging the angular distance to the kth neighbor of each datapoint to create a set of hypercones within which the ID data lies, but the disclosure is not limited thereto.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium may be a random access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, may be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, may be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for distinguishing in-distribution data from out-of-distribution data, the method being implemented by at least one processor, the method comprising:
accessing a set of data that is usable in connection with a feature encoder that includes a plurality of layers, the feature encoder being defined by an input space that includes a predetermined number of features and a label output space that includes a predetermined number of labels;
extracting, from a penultimate layer from among the plurality of layers, a set of features;
using a predetermined feature encoder function that is designed to map the input space to a feature output space that corresponds to the set of features to generate, for each respective datapoint included in the set of data, a respective embedding;
using each respective embedding to compute, for each respective label included in the label output space, a respective cluster centroid;
computing, for each respective label by using each respective embedding and each respective cluster centroid, a respective set of hypercone axes;
calculating, for each respective label by using the data, a respective set of hypercone opening angles;
generating a contour that corresponds to the label output space by projecting, for each respective cluster centroid, each respective hypercone axis, and each respective hypercone opening angle, a respective hypercone in a respective direction based on the data;
using the contour to distinguish, from within the set of data, in-distribution data from out-of-distribution data; and
training a predetermined model using a subset of the set of data that includes the in-distribution data and excludes the out-of-distribution data.

2. The method of claim 1, wherein the calculating of each respective hypercone opening angle comprises:
using, for each respective label, a respective subset of the data that corresponds to the respective label to determine, for each respective item of the respective subset of the data, a respective kth nearest neighbor in cosine distance for a predetermined value of k;
measuring a respective angle between each respective item of the respective subset of the data and the respective kth nearest neighbor; and
setting the measured respective angle as the respective hypercone opening angle.

3. The method of claim 1, further comprising determining, for each respective hypercone, a respective radial boundary by:
for each respective item of the data that falls within an angular boundary of the respective hypercone, measuring a respective distance from the respective cluster centroid; and
applying a predetermined statistical formula with respect to the measured respective distances to determine the respective radial boundary.

4. The method of claim 1, wherein at least a first respective hypercone overlaps with at least a second respective hypercone, such that at least one item of data included in the data falls within both the first respective hypercone and the second respective hypercone.

5. The method of claim 1, further comprising:
determining, based on the contour, whether a particular item from within a first set of input observational data is classifiable as an in-distribution data item.

6. The method of claim 5, wherein each respective hypercone includes a respective angular boundary and a respective radial boundary, and
wherein the determining of whether the particular item is an in-distribution data item comprises determining whether the particular item falls within both the respective angular boundary and the respective radial boundary of at least one respective hypercone used for generating the contour.

7. The method of claim 6, further comprising:
when a determination is made that the particular item does not fall within both the respective angular boundary and the respective radial boundary of the at least one respective hypercone used for generating the contour, classifying the particular item as an out-of-distribution item.

8. The method of claim 5, further comprising classifying 95% of items included in the first set of input observational data as in-distribution data items and classifying 5% of the items included in the first set of input observational data as out-of-distribution data items.

9. A computing apparatus for distinguishing in-distribution data from out-of-distribution data, the computing apparatus comprising:
a processor;
a memory; and
a communication interface coupled to each of the processor and the memory,
wherein the processor is configured to:
access a set of data that is usable in connection with a feature encoder that includes a plurality of layers, the feature encoder being defined by an input space that includes a predetermined number of features and a label output space that includes a predetermined number of labels;
extract, from a penultimate layer from among the plurality of layers, a set of features;
use a predetermined feature encoder function that is designed to map the input space to a feature output space that corresponds to the set of features to generate, for each respective datapoint included in the set of data, a respective embedding;
use each respective embedding to compute, for each respective label included in the label output space, a respective cluster centroid;
compute, for each respective label by using each respective embedding and each respective cluster centroid, a respective set of hypercone axes;
calculate, for each respective label by using the data, a respective set of hypercone opening angles;
generate a contour that corresponds to the label output space by projecting, for each respective cluster centroid, each respective hypercone axis, and each respective hypercone opening angle, a respective hypercone in a respective direction based on the data;
use the contour to distinguish, from within the set of data, in-distribution data from out-of-distribution data; and
train a predetermined model using a subset of the set of data that includes the in-distribution data and excludes the out-of-distribution data.

10. The computing apparatus of claim 9, wherein the processor is further configured to calculate each respective hypercone opening angle by:
using, for each respective label, a respective subset of the data that corresponds to the respective label to determine, for each respective item of the respective subset of the data, a respective kth nearest neighbor in cosine distance for a predetermined value of k;
measuring a respective angle between each respective item of the respective subset of the data and the respective kth nearest neighbor; and
setting the measured respective angle as the respective hypercone opening angle.

11. The computing apparatus of claim 9, wherein the processor is further configured to determine, for each respective hypercone, a respective radial boundary by:
for each respective item of the data that falls within an angular boundary of the respective hypercone, measuring a respective distance from the respective cluster centroid; and
applying a predetermined statistical formula with respect to the measured respective distances to determine the respective radial boundary.

12. The computing apparatus of claim 9, wherein at least a first respective hypercone overlaps with at least a second respective hypercone, such that at least one item of data included in the data falls within both the first respective hypercone and the second respective hypercone.

13. The computing apparatus of claim 9, wherein the processor is further configured to:
determine, based on the contour, whether a particular item from within a first set of input observational data is classifiable as an in-distribution data item.

14. The computing apparatus of claim 13, wherein each respective hypercone includes a respective angular boundary and a respective radial boundary, and
wherein the processor is further configured to determine whether the particular item is an in-distribution data item by determining whether the particular item falls within both the respective angular boundary and the respective radial boundary of at least one respective hypercone used for generating the contour.

15. The computing apparatus of claim 14, wherein the processor is further configured to:
when a determination is made that the particular item does not fall within both the respective angular boundary and the respective radial boundary of the at least one respective hypercone used for generating the contour, classify the particular item as an out-of-distribution item.

16. The computing apparatus of claim 13, wherein the processor is further configured to classify 95% of items included in the first set of input observational data as in-distribution data items and to classify 5% of the items included in the first set of input observational data as out-of-distribution data items.

17. A non-transitory computer readable storage medium storing instructions for distinguishing in-distribution data from out-of-distribution data, the storage medium comprising executable code which, when executed by a processor, causes the processor to:
access a set of data that is usable in connection with a feature encoder that includes a plurality of layers, the feature encoder being defined by an input space that includes a predetermined number of features and a label output space that includes a predetermined number of labels;
extract, from a penultimate layer from among the plurality of layers, a set of features;
use a predetermined feature encoder function that is designed to map the input space to a feature output space that corresponds to the set of features to generate, for each respective datapoint included in the set of data, a respective embedding;
use each respective embedding to compute, for each respective label included in the label output space, a respective cluster centroid;
compute, for each respective label by using each respective embedding and each respective cluster centroid, a respective set of hypercone axes;
calculate, for each respective label by using the data, a respective set of hypercone opening angles;
generate a contour that corresponds to the label output space by projecting, for each respective cluster centroid, each respective hypercone axis, and each respective hypercone opening angle, a respective hypercone in a respective direction based on the data;
use the contour to distinguish, from within the set of data, in-distribution data from out-of-distribution data; and
train a predetermined model using a subset of the set of data that includes the in-distribution data and excludes the out-of-distribution data.

18. The storage medium of claim 17, wherein when executed, the executable code further causes the processor to:
determine, based on the contour, whether a particular item from within a first set of input observational data is classifiable as an in-distribution data item.

19. The storage medium of claim 18, wherein each respective hypercone includes a respective angular boundary and a respective radial boundary, and
wherein when executed, the executable code further causes the processor to determine whether the particular item is an in-distribution data item by determining whether the particular item falls within both the respective angular boundary and the respective radial boundary of at least one respective hypercone used for generating the contour.

20. The storage medium of claim 19, wherein when a determination is made that the particular item does not fall within both the respective angular boundary and the respective radial boundary of the at least one respective hypercone used for generating the contour, the executable code further causes the processor to classify the particular item as an out-of-distribution item.
